(19) United States
(12) Patent Application Publication
(10) Pub. No.: US 2009/0097911 A1
(43) Pub. Date: Apr. 16, 2009

(54) LOCKING DEVICE

(75) Inventors: Chin-Jui Chuang, Taipei City (TW); Chien-Chung Chien, Taipei City (TW); Shu-Hua Yeh, Taipei City (TW); Yi-Wei Chang, Taipei City (TW); Chia-Chen Chen, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/042,991

(22) Filed: Mar. 5, 2008

(30) Foreign Application Priority Data
Oct. 16, 2007 (TW) 96138667

(51) Int. Cl. E05B 65/00

(52) U.S. Cl. 403/323; 70/57

(57) ABSTRACT

A locking device suitable to lock a locking hole is disclosed. The locking device includes a body having a first locking portion, a locking element suitable to rotate between a first position and a second position, and an elastic element. The locking element includes a connecting portion passing through the body, a second locking portion connected to an end of the connecting portion, and an operating portion connected to another end of the connecting portion. An end of the elastic element is fixed at the body and another end thereof is fixed at the operating portion. The elastic element is elastically compressed between the body and the operating portion. When the locking device is located at the first position, the second locking portion is suitable to lock the locking hole. When the locking element is located at the second position, the second locking portion does not lock the locking hole.

### CROSS-REFERENCE TO RELATED APPLICATION

This application claims the priority benefit of Taiwan application serial No. 96138667, filed on Oct. 16, 2007. The entirety the above-mentioned patent application is hereby incorporated by reference herein and made a part of specification.

### BACKGROUND OF THE INVENTION

1. Field of the Invention

The present invention generally relates to a locking device, and more particularly, to a locking device to lock a locking hole.

2. Description of Related Art

A portable electronic device is advantageous in that a user is able to carry the portable electronic device and to manipulate the portable electronic device in diverse working environments.

When a portable electronic device (for example, a notebook computer) is somewhat heavy and a user wishes to carry the somewhat heavy portable electronic device, the user needs to place the portable electronic device in a bag-resembling object and carry it by taking in hand or carrying over shoulder the bag-resembling object. However, the above-mentioned bag-resembling object with the portable electronic device placed therein, the overall volume thereof would be pretty greater than the portable electronic device alone, which causes much inconvenience for a user to carry.

### SUMMARY OF THE INVENTION

Accordingly, the present invention is directed to a locking device suitable to lock a portable electronic device.

The present invention provides a locking device for locking a locking hole. The locking device includes a body, a locking element and an elastic element. The body has a first locking portion. The locking element is suitable to rotate between a first position and a second position and includes a connecting portion, a second locking portion and an operating portion. The connecting portion passes through the body. The second locking portion connects an end of the connecting portion, and the operating portion connects another end of the connecting portion. An end of the elastic element is fixed at the body, and another end of the elastic element is fixed at the operating portion, and the elastic element is elastically compressed between the body and the operating portion. When the locking element is located at the first position, the second locking portion is suitable to lock the locking hole. When the locking element is located at the second position, the second locking portion locks the first locking portion, the second locking portion does not lock the locking hole, and the elastic element is affected by a torque to elastically deform.

In an embodiment of the present invention, the above-mentioned body includes a base and a protrusion. The protrusion is disposed on the base, the first locking portion is disposed on the protrusion and the connecting portion passes through the protrusion and the base.

In an embodiment of the present invention, the above-mentioned operating portion and the body can together form an accommodating space, and the elastic element is located in the accommodating space.

In an embodiment of the present invention, the above-mentioned first locking portion can be a locking slot, and the second locking portion can have a locking block.

In an embodiment of the present invention, the above-mentioned first locking portion can be a locking block, and the second locking portion can have a locking slot.

In an embodiment of the present invention, the above-mentioned elastic element can be a spring coil and the elastic element coils the connecting portion.

Since the locking element of the present invention is able to rotate between the first position and the second position, therefore, it is easier and more convenient for a user to use the locking device of the present invention to lock the locking hole and to detach the locking device from the locking hole. In addition, since the locking device of the present invention can associate with a band-resembling object together to be used in a portable electronic device, such that a user conveniently carries the portable electronic device. Thus, in comparison with the prior art, the locking device of the present invention enables users to more conveniently carry the portable electronic device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic exploded 3D-drawing of a locking device according to an embodiment of the present invention.

FIG. 2 is a schematic assembly drawing of the locking device of FIG. 1.

FIGS. 3A-3D are diagrams showing a rotating course of the locking element of the locking device in FIG. 1 from the first position to the second position.

FIG. 4 is a diagram of a locking device provided by the present invention and a portable electronic device where the locking device is used.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

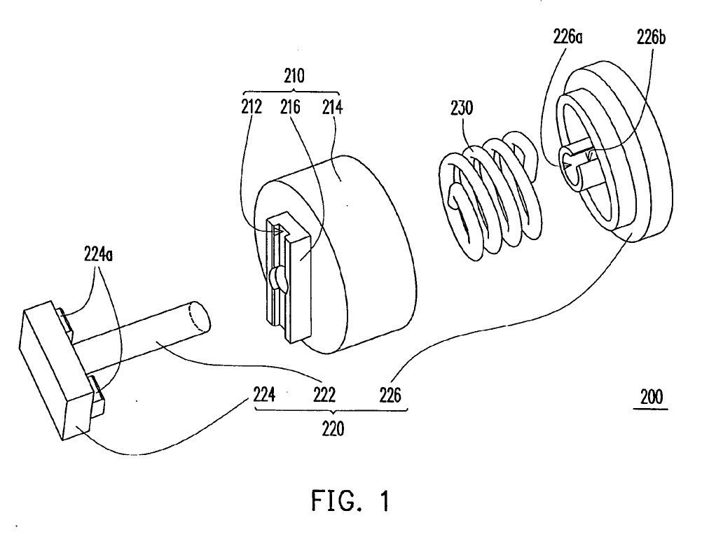

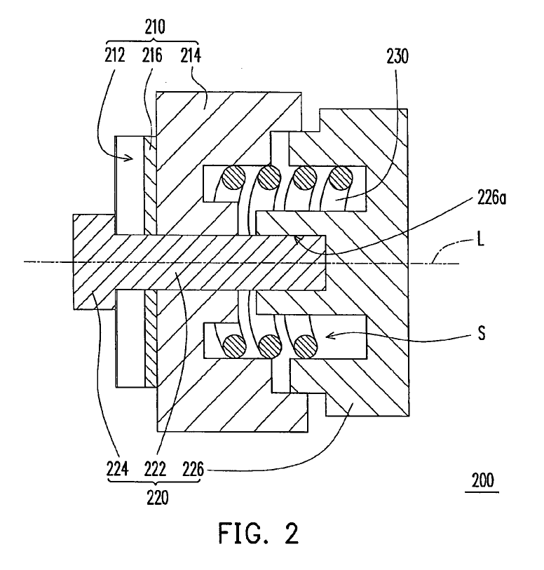

FIG. 1 is a schematic exploded 3D-drawing of a locking device according to an embodiment of the present invention and FIG. 2 is a schematic assembly drawing of the locking device of FIG. 1. Referring to FIGS. 1 and 2, a locking device 200 of the embodiment includes a body 210, a locking element 220 and an elastic element 230. The body 210 has a locking portion 212 a base 214 and a protrusion 216. The protrusion 216 is disposed on the base 214 and the locking portion 212 is disposed on the protrusion 216. The locking portion 212 of the present embodiment is, for example, a locking slot.

The locking element 220 includes a connecting portion 222, a locking portion 224 and an operating portion 226. The connecting portion 222 passes through the body 210; in the embodiment, the connecting portion 222 passes through the protrusion 216 and the base 214. The locking portion 224 is connected to an end of the connecting portion 222, and the operating portion 226 is connected to another end of the connecting portion 222. In the embodiment, the locking portion 224 and the connecting portion 222 can be integrally formed. The operating portion 226 can have a fixing hole 226a and an end of the connecting portion 222 far from the locking portion 224 is fixed in the fixing hole 226a. Besides, the locking portion 224 can have at least one locking block 224a (two locking blocks are exemplarily shown in FIG. 1).

An end of the elastic element 230 is fixed at the body 210, for example, fixed at the base 214 of the body 210, and another end of the elastic element 230 is fixed at the operating portion 226, for example, fixed at a fixing slot 226b of the operating portion 226. The elastic element 230 is elastically compressed along a line L between the body 210 and the operating portion 226. In the embodiment, the operating portion 226 and the body 210 can together form an accommodating space S, and the elastic element 230 is located in the accommodating space S. In addition, the elastic element 230 can be a spring coil and the elastic element 230 coils the connecting portion 222.

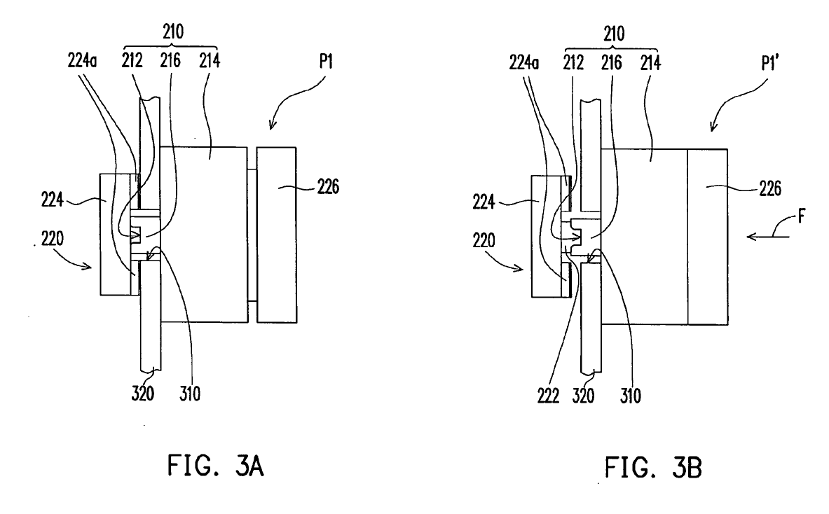

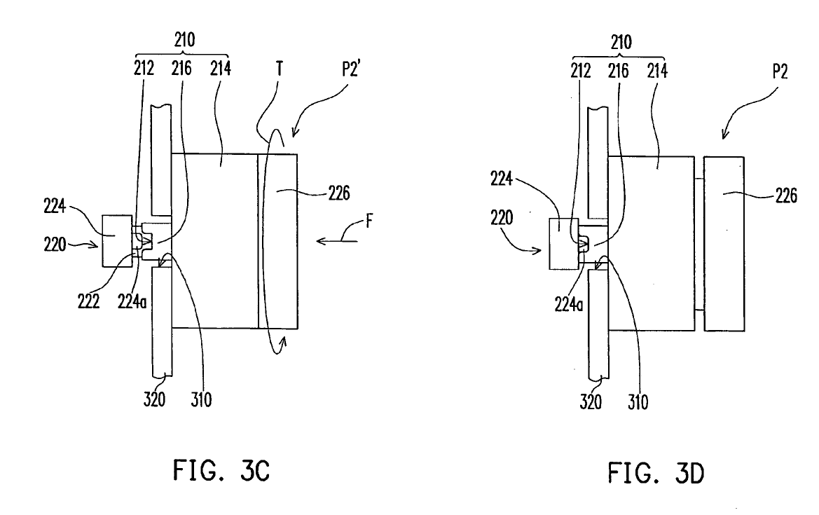

The locking and unlocking course of the locking device 200 is explained in the following. FIGS. 3A-3D are diagrams showing a rotating course of the locking element of the locking device in FIG. 1 from the first position to the second position. Referring to FIG. 3A, when the locking element 220 is located at a first position P1, the locking portion 224 of the locking element 220 is suitable to lock a locking hole 310, and the locking hole 310 herein is located on a casing 320 of a portable electronic device (not shown).

Referring to FIGS. 3A and 3B, when a user exerts an external force F to push the operating portion 226, the elastic element 230 (shown in FIG. 1) is compressed and the locking element 220 moves from the first position P1 to a first intermediate position P1′.

Referring to FIGS. 3B and 3C, when the user then exerts a torque T to rotate the operating portion 226, the elastic element 230 (FIG. 1) is affected by the torque to elastically deform, the locking element 220 rotates from the first intermediate position P1′ to a second intermediate position P2′ and the locking portion 224 of the locking element 220 does not lock the locking hole 310. At this time, the positions of the locking blocks 224a of the locking portion 224 are corresponding to the position of the locking portion 212 such as the locking slot.

Referring to FIGS. 3C and 3D, when the user does not exert the external force F, the elastic element 230 pushes the operating portion 226 so as to move the locking element 220 from the second intermediate position P2′ to a second position P2. At the time, the locking portion 224 of the locking element 220 does not lock the locking hole 310, and the locking portion 224 locks the locking portion 212 of the body 210. In more detail, the locking blocks 224a of the locking portion 224 lock the locking portion 212 such as the locking slot. It is noted although the user at the time does not exert the torque T and the external force F, however, the locking portion 224 of the locking element 220 still locks the locking portion 212 of the body 210, so that the elastic element 230 is affected by another torque (not shown) having the almost same amount as the torque T has and the same direction as the torque T has. In other words, when the locking element 220 is located at the second position P2, the elastic element 230 exerts a restore torque (not shown) on the locking element 220, wherein the restore torque has the almost same amount as the torque T has and the direction of the restore torque is opposite to that of the torque T.

It is remarkable since the locking portion 224 does not lock a locking hole 310 when the locking element 220 is located at the second position P2, the user is able to detach the locking device 200 from the locking hole 310. In addition, since the elastic element 230 exerts a restore torque (not shown) on the locking element 220 (as described above) when the locking element 220 is located at the second position P2, therefore, once the user needs to re-fasten the locking device 200 to the locking hole 310, what to be done is merely to press the operating portion 226, so that the locking portion 224 of the locking element 220 does not lock the locking portion 212 of the body 210, and the locking element 220 on which the elastic element 230 exerts the restore torque (not shown) rotates to the first position P1 in the direction opposite to the direction of the torque T.

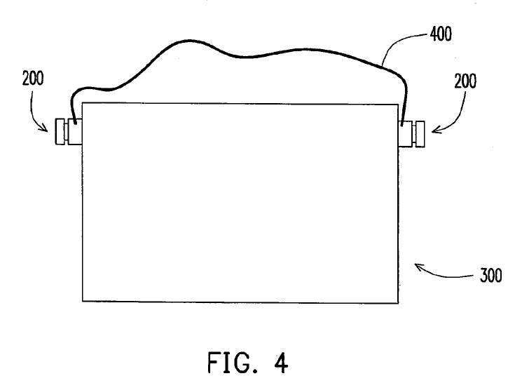

FIG. 4 is a diagram of a locking device provided by the present invention and a portable electronic device where the locking device is used. Referring to FIG. 4, if a user wants to carry a portable electronic device 300, the user needs to respectively lock two locking devices 200 to two locking holes (not shown) of the portable electronic device 300, so that the portable electronic device 300 is able to be carried over shoulder of the user by means of the band-resembling object 400 connecting the locking devices 200.

In summary, the locking device of the present invention has at least following advantages:

1. Since the locking element of the present invention is able to rotate between the first position and the second position, thus, it is easier and more convenient to use the locking device of the present invention to lock the locking hole and to detach the locking device from the locking hole.

2. Associated with a band-resembling object, the locking device of the present invention is able to be applied in a portable electronic device such that a user conveniently carries the portable electronic device. In comparison with the prior art, the locking device of the present invention enables the user to more conveniently carry the portable electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A locking device, suitable to lock a locking hole, comprising:
a body, having a first locking portion;
a locking element, suitable to rotate between a first position and a second position, comprising:
a connecting portion, passing through the body;
a second locking portion, connected to an end of the connecting portion; and
an operating portion, connected to another end of the connecting portion; and
an elastic element, wherein an end of the elastic element is fixed at the body, another end of the elastic element is fixed at the operating portion and the elastic element is elastically compressed between the body and the operating portion,
wherein when the locking element is located at the first position, the second locking portion is suitable to lock the locking hole, when the locking element is located at the second position, the second locking portion locks the first locking portion, the second locking portion does not lock the locking hole and the elastic element is affected by a torque to elastically deform.

2. The locking device according to claim 1, wherein the body comprises:
a base; and
a protrusion, disposed on the base, wherein the first locking portion is disposed on the protrusion and the connecting portion passes through the protrusion and the base.

3. The locking device according to claim 1, wherein the operating portion and the body together form an accommodating space and the elastic element is located in the accommodating space.

4. The locking device according to claim 1, wherein the first locking portion is a locking slot and the second locking portion has a locking block.

5. The locking device according to claim 1, wherein the first locking portion is a locking block and the second locking portion has a locking slot.

6. The locking device according to claim 1, wherein the elastic element is a spring coil and the elastic element coils the connecting portion.
